(19) United States
(12) Patent Application Publication
(10) Pub. No.: US 2014/0061334 A1
(43) Pub. Date: Mar. 6, 2014

(54) SPRAY GUN

(71) Applicant: Ying-Chieh LIAO, Taichung City (TW)

(72) Inventor: Ying-Chieh LIAO, Taichung City (TW)

(21) Appl. No.: 13/604,570

(22) Filed: Sep. 5, 2012

(51) Int. Cl. B05B 7/32

(52) U.S. Cl. 239/315

(57) ABSTRACT

A spray gun includes a controller, an expanding tube, a spray tube, and a connector between the controller and the spray tube. A fluid container communicates with the connector via a fluid tube. An inner tube is disposed in the spray tube and has an end communicating with the fluid tube. The expanding tube is disposed around the spray tube and has a restrict portion formed inside to sleeved around the inner tube. When pulling the trigger to drive gas to enter the connector and the spray tube, fluid in the fluid container is sucked out to be mixed with the gas in the spray tube so that the spray tube swings to spray out. Thereby, the spray tube can swing only in a restricted range instead of swinging irregularly.

### BACKGROUND OF THE INVENTION

1. Field of the Invention

The present invention relates to a spray gun.

2. Description of the Prior Art

A conventional spray gun utilizes pressured-gas to bring and to suck fluid in fluid container out, and gas and fluid are blended to form spray mist. More specifically, the spray gun alternatively has a solid spray tube made of metal or a resilient spray tube. The terminal end of a solid spray tube is usually inclined. When high-speed gas bringing fluid enters the spray tube, the spray tube rotates due to the resistance to spray mist by the inclined terminal end of the spray tube so that the spray mist can be sprayed over a large area. On the contrary, resilient spray tube doesn't have to have an inclined terminal end. A resilient spray tube can bend slightly, so the spray tube may swing irregularly when high-speed gas and fluid enter the spray tube. Thus, spraying can be achieved in a similar manner.

However, conventional resilient spray tubes swing too freely and have an irregular track of spraying. Also, irregular spraying results that spray mist is wasted while sprayed on the inner wall of the spray gun. Cleaning is also troublesome for users.

The present invention is, therefore, arisen to obviate or at least mitigate the above mentioned disadvantages.

### SUMMARY OF THE INVENTION

The main object of the present invention is to provide a spray gun which has a restricted swinging range and has multiple gas sources to make mist spray finer.

To achieve the above and other objects, the spray gun of the present invention includes a connector, a controller, an expanding tube, a resilient spray tube, a fluid container, and an inner tube.

The connector has a first end and an opposite second end. The controller connects the first end of the connector and a pressured-gas source therebetween and is able to alternatively allow gas from the pressured-gas source to enter the connector.

The expanding tube is disposed at an end of the spray gun opposite to the controller. An end of the expanding tube away from the controller forms a mixing portion which has diverging internal diameters. A hollow restrict portion which has a predetermined length is disposed on an inner wall of the expanding tube, wherein the restrict portion and the expanding tube extend coaxially.

The spray tube is disposed in the restrict portion. One end of the spray tube communicates with the second end of the connector, and an opposite end is located in the mixing portion and is protruded outside of the restrict portion.

The fluid container communicates with the connector via a fluid tube which is inserted into the fluid container. The inner tube is disposed in the spray tube and the connector, and an end of the inner tube communicates with the end of the fluid tube in the connector.

In practice, when gas from the pressured-gas source is spouted from the spray tube to trigger the spray tube swing, the swinging range of the spray tube is restricted by the restrict portion.

Besides, the spray gun of the present invention further includes a secondary ventilating tube disposed outside of the connector. One end of the secondary ventilating tube is connected with the controller, and an opposite end of the secondary ventilating tube is connected with the expanding tube so that the controller directly communicates with the mixing portion via the secondary ventilating tube to provide additional gas source. Thus, spray mixed in the mixing portion can be further nebulized to form a finer mist.

Thereby, the spray gun of the present invention has a spray tube which has a restricted swinging range and is more stable, and the additional gas sources can also help nebulization.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a lateral profile of the present invention;

FIG. 4 is a top view profile of the present invention;

FIGS. 5A to 5D are operation views of the present invention;

FIG. 6 is a stereogram showing a second embodiment of the present invention;

FIG. 7 is a profile showing a second embodiment of the present invention.

### DETAILED DESCRIPTION OF THE PREFERRED EMBODIMENTS

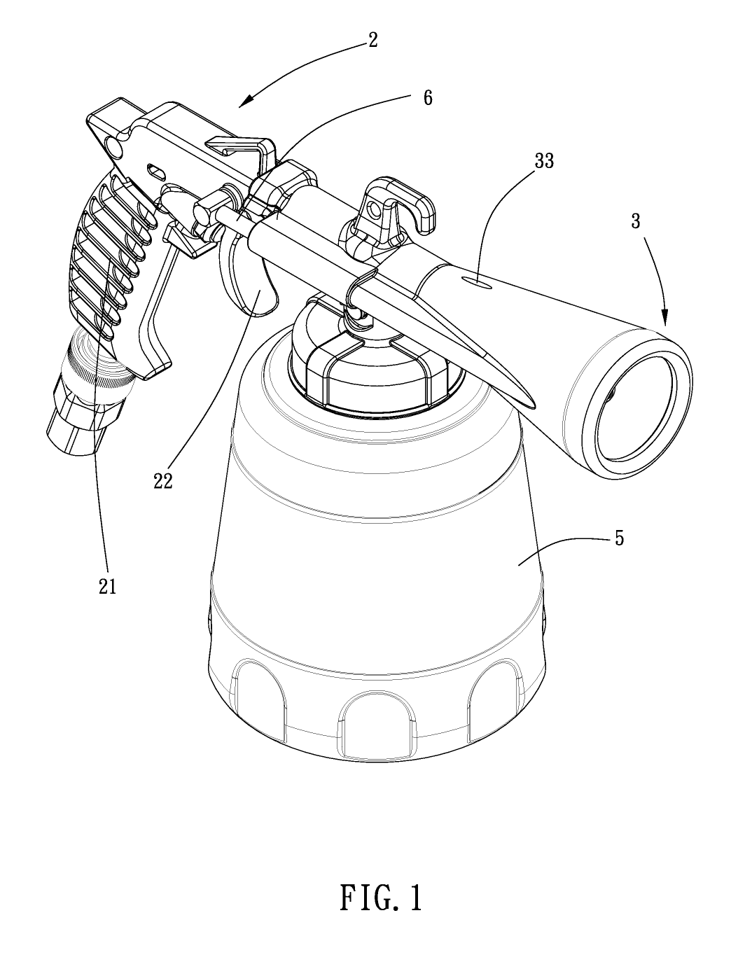

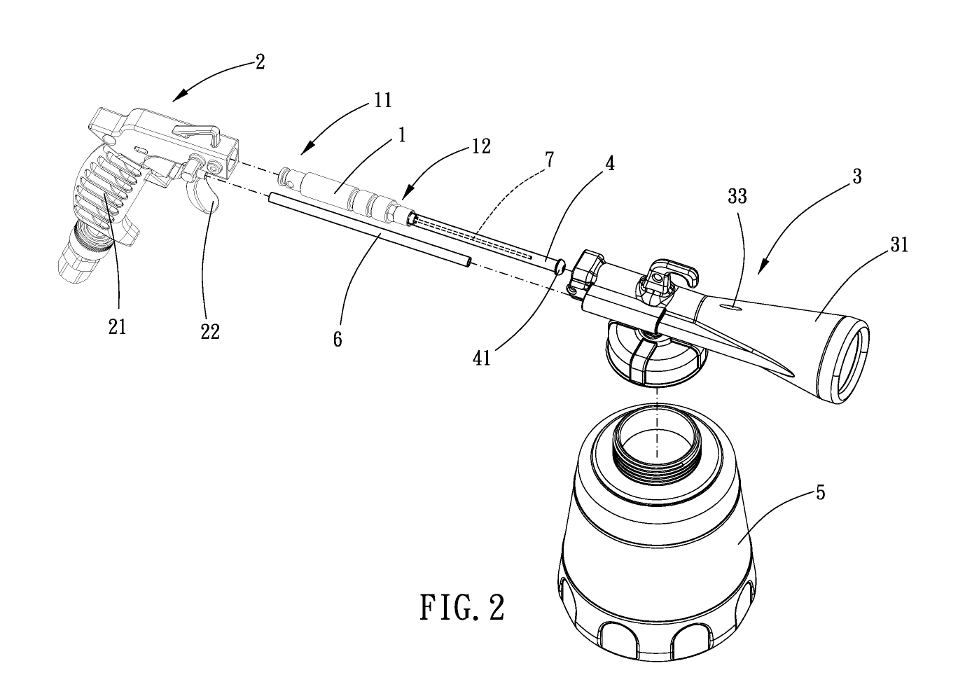

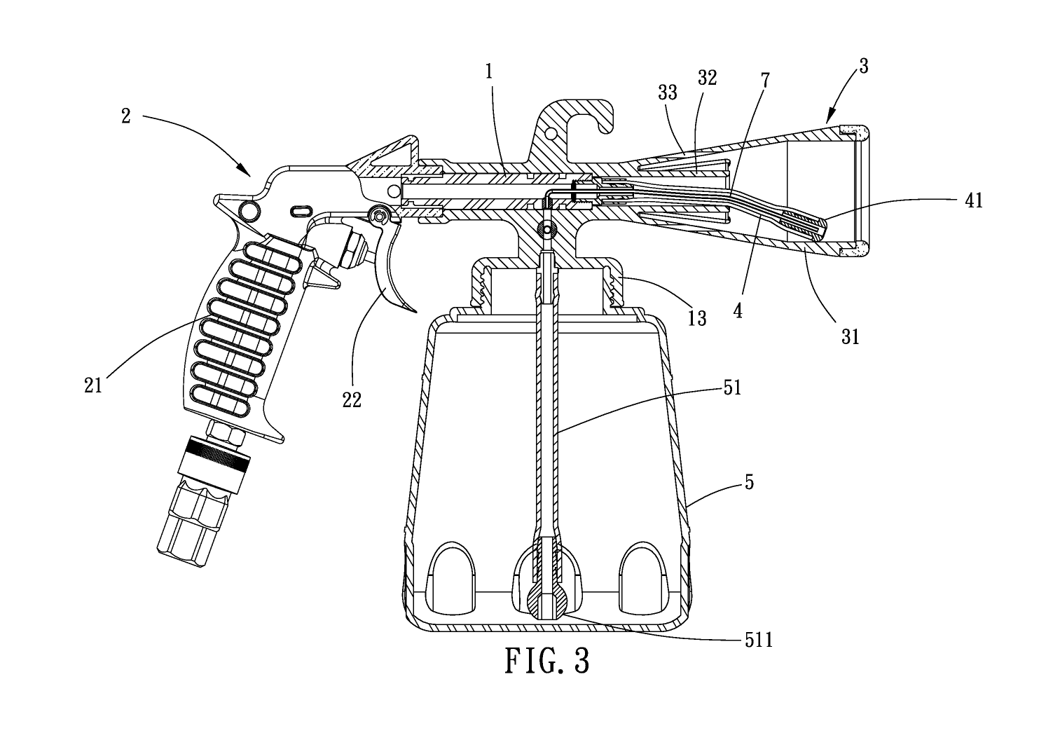

Please refer to FIG. 1 to FIG. 4. The spray gun of the present embodiment includes a connector 1, a controller 2, an expanding tube 3, a resilient spray tube, a fluid container 5, a secondary ventilating tube 6, and an inner tube 7.

The connector 1 has a first end and 11 and an opposite second end 12. More preferably, the connector 1 is enclosed by a shell.

The controller 2 connects the first end 11 of the connector 1 and a pressured-gas source therebetween to alternatively allow gas from the pressured-gas source to enter the connector 1.

The expanding tube 3 is disposed at an end of the spray gun opposite to the controller 2. An end of the expanding tube 3 away from the controller 2 disposes a mixing portion 31 which has diverging internal diameters. In addition, a hollow restrict portion 32 in a predetermined length is disposed on an inner wall of the expanding tube 3, and the restrict portion 32 and the expanding tube 3 extend coaxially. More preferably, the restrict portion 32 is integrally formed on the inner wall of the expanding tube 3 and is tunnel-shaped.

The spray tube 4 is disposed in the restrict portion. An end of the spray tube 4 communicates with the second end 12 of the connector 1, and an opposite end of the spray tube 4 is exposed outside the restrict portion 32 in the mixing portion 31. More preferably, the end of the spray tube 4 in the mixing portion 31 disposes a counterweight head 41 so that the end of the spray tube 4 in the mixing portion 31 is heavier than the other end. Thus, the spray tube 4 is able to swing regularly.

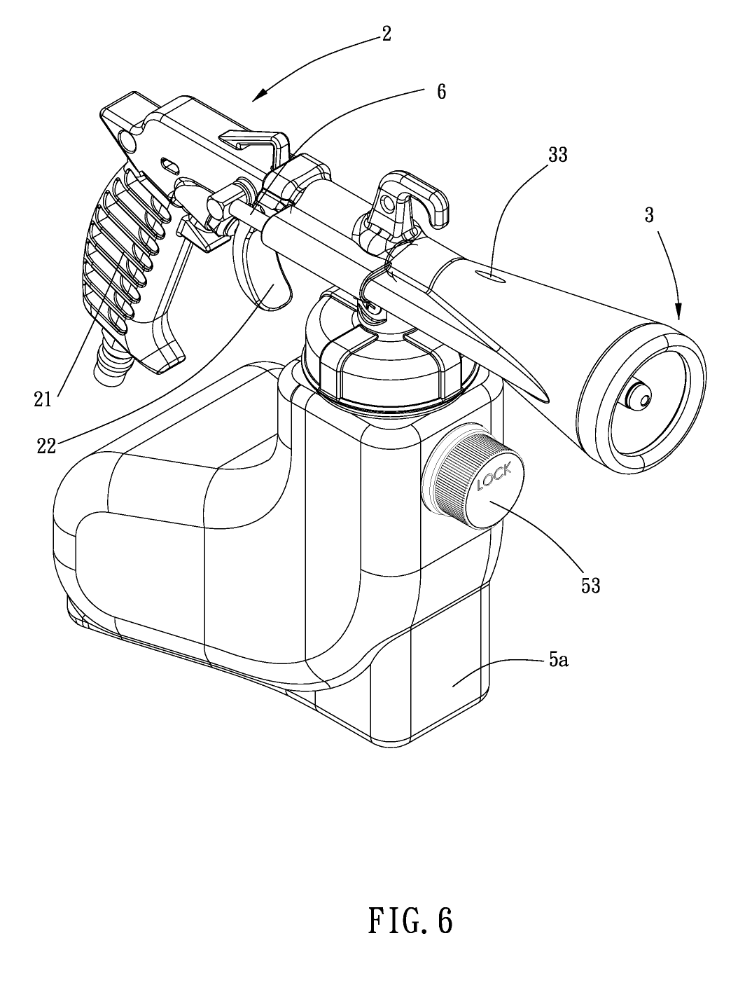

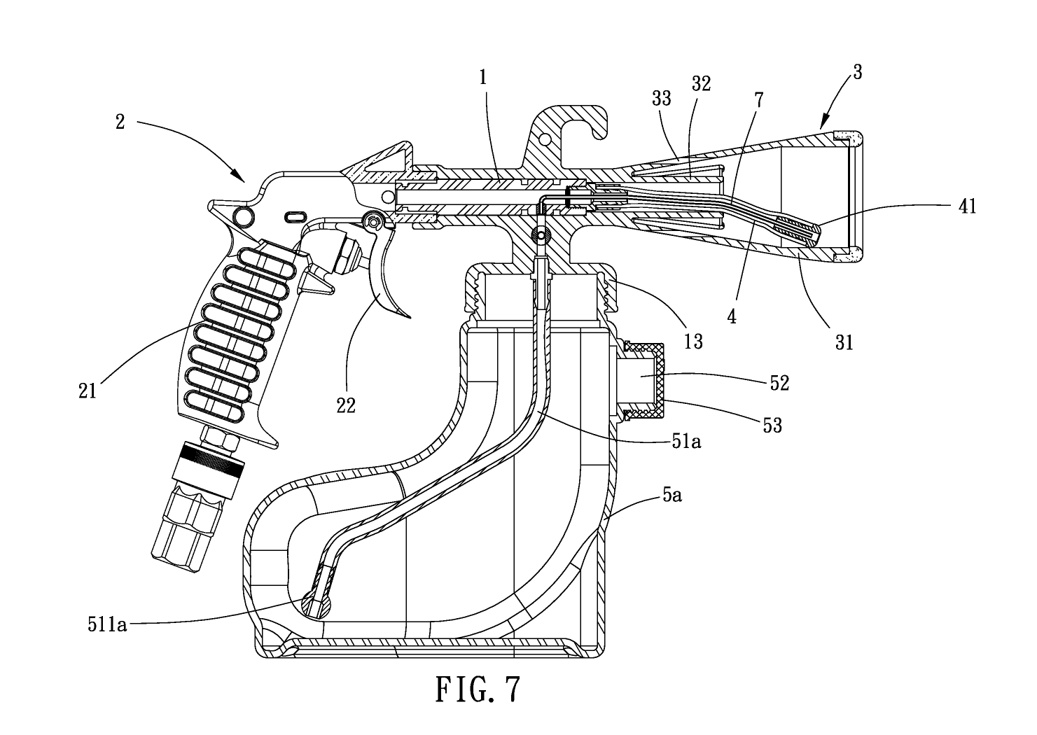

The fluid container 5 communicates with the connector 1 via a fluid tube 51 which is inserted into the fluid container 5. An end of the fluid tube 51 away from the connector 1 is a free end and is immersed in fluid in the fluid container 5. More preferably, the free end disposes a drooping piece 511 so that the fluid tube 51 tends to droop down toward the ground. Thereby, even if the fluid container 5 is inclined, the free end can still be immersed in the fluid for continuous operation. In addition, the fluid container 5 has a top portion and a bottom portion. The top portion forms an opening, and a circumference of the opening forms external threads. The connector 1 forms a cover 13 at an end close to the fluid container 5, and the cover 13 forms internal threads to be screwed with the external threads of the fluid container 5 so that the fluid container can be sealed better. In a possible embodiment of the present invention, as shown in FIGS. 6 and 7, the bottom portion of the fluid container 5a bends toward the controller 2 so that the fluid container 5a is substantially L-shaped. Also, the fluid tube 51a also bends corresponding to a shape of the fluid container 5a, and the end of the fluid tube 51a away from the connector 1 extends to an end of the bottom portion of the fluid container 5a close to the controller 2. Thereby, when the spray gun sprays upward, fluid in the fluid container 5a accumulates the bending portion of the bottom portion so that the drooping piece 511a can be entirely immersed in fluid. Thus, the spray gun can spray continuously without any disruption. More preferably, the fluid container 5a further forms a replenish inlet 52 and a sealer 53 detachably covering the replenish inlet 52. Thereby, when replenishing fluid to the fluid container 5a, the fluid container 5a doesn't have to be detached entirely.

The inner tube 7 is disposed in the spray tube 4 and the connector 1. An end of the inner tube 7 communicates with an end of the fluid tube 51 in the connector 1, and an opposite end of the inner tube 7 extends near an end of the spray tube 4 having the counterweight head 41. Thereby, fluid in the fluid container 5 can be sucked into the spray tube 4 to be mixed with gas to form spray mist.

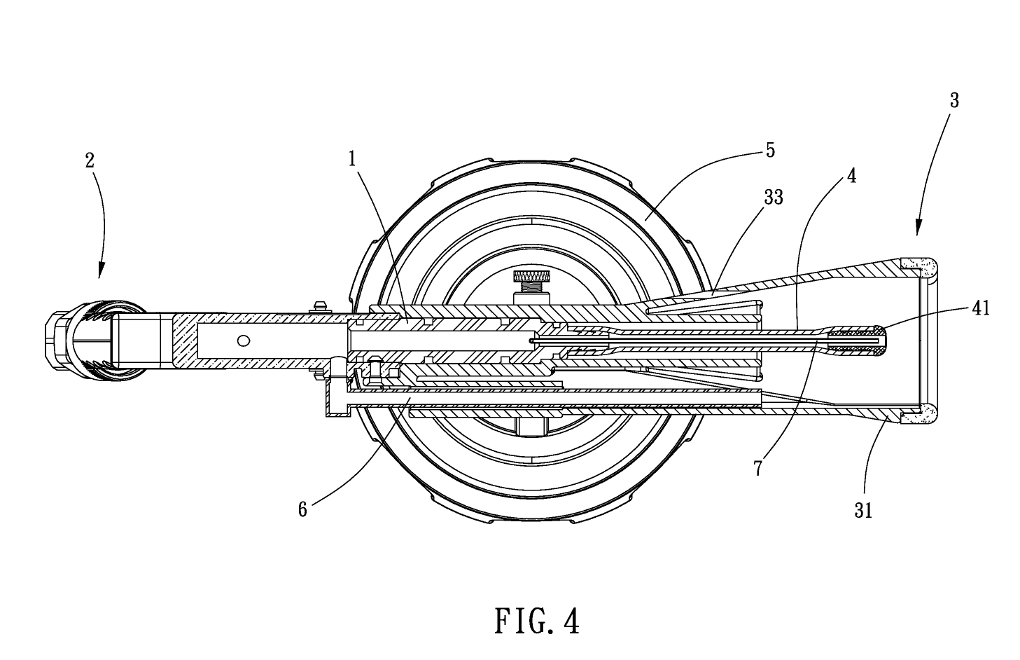

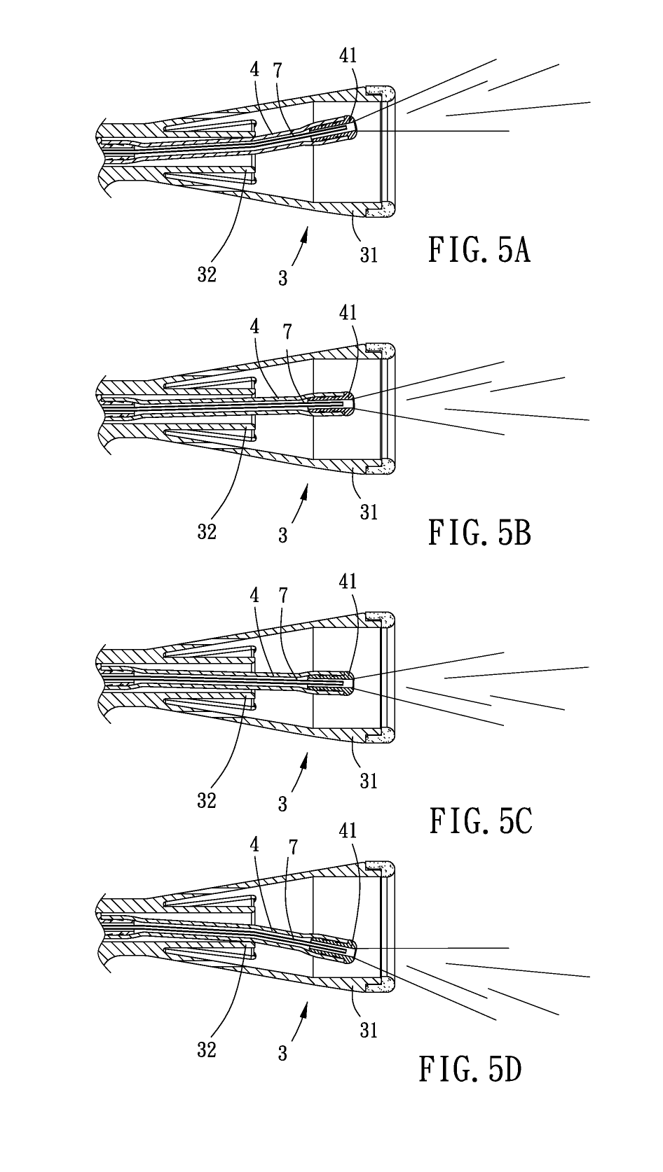

Please refer to FIGS. 4 and 5A to 5D. When the trigger is pulled, gas from the pressured-gas source enters the connector 1 and the spray tube 4 in a high speed. Due to the Venturi effect, fluid in the fluid container 5 is sucked out by the high-speed gas, and then the fluid and the gas are mixed and nebulized. The terminal end of the spray tube 4 is shocked by the high-speed spray to swing so that the spray mist is sprayed outward. More importantly, the spray tube 4 is restricted by the restrict portion 32 to kept at center. Thus, the spray tube 4 is able to swing limitedly and regularly.

Please refer to FIGS. 1 to 4 again for other possible embodiments. The expanding tube 3 forms at least one ventilating opening 33 allowing air outside to enter the mixing portion 31 so that fluid and gas can be blended adequately to form finer mist. On the other hand, the spray gun can further dispose a secondary ventilating tube 6 adjacent to outside of the connector 1. An end of the secondary ventilating tube 6 is connected with the controller 2, and an opposite end of the secondary ventilating tube 6 communicates with the expanding tube 3 so that the controller 2 communicates with the mixing portion 31 via the second ventilating tube 6. Thus, high-speed gas is able to directly enter the mixing portion 31 for further nebulization of spray mist via the second ventilating tube 6.

In conclusion, the spray gun of the present invention provides a spray tube which is able to swing stably and regularly, and additional gas sources are provided for further nebulization to form finer mist.

What is claimed is:

1. A spray gun, including:
a connector, having a first end and an opposite second end;
a controller, connected the first end of the connector and a pressured-gas source therebetween, the controller being able to alternatively allow gas from the pressured-gas source to enter the connector;
an expanding tube, disposed on an end of the spray gun opposite to the controller, the expanding tube having a mixing portion at an end away from the controller, a hollow restrict portion which has a predetermined length being disposed on an inner wall of the expanding tube, the restrict portion and the expanding tube extending coaxially;
a resilient spray tube, disposed in the restrict portion, an end of the spray tube communicating and being connected with the second end of the connector, an opposite end of the spray tube being located in the mixing portion but exposed outside of the restrict portion;
a fluid container, a fluid tube extending from inside of the fluid container into the connector;
an inner tube, disposed in the spray tube and the connector, an end of the inner tube communicating with an end of the fluid tube in the connector;
wherein swinging range of the spray tube is restricted by the restrict portion when gas from the pressured-gas source is spouted from the spray tube to trigger the spray tube to swing.

2. The spray gun of claim 1, further including a secondary ventilating tube located outside the connector, an end of the secondary ventilating tube connecting with the controller, an opposite end of the secondary ventilating tube connecting with the expanding tube so that the controller communicates with the mixing portion via the secondary ventilating tube.

3. The spray gun of claim 1, wherein at least one ventilating opening is formed on a wall of the expanding tube to allow air outside to enter the mixing portion.

4. The spray gun of claim 1, wherein the controller includes a handle and a trigger, gas from the pressured-gas source is able to enter the connector when the trigger is pulled.

5. The spray gun of claim 1, wherein the restrict portion is integrally formed on the inner wall of the expanding tube and is tunnel-shaped.

6. The spray gun of claim 1, wherein a counterweight head is disposed at the end of the spray tube in the mixing portion so that the end of the spray tube in the mixing portion is heavier than the opposite end of the spray tube.

7. The spray gun of claim 1, wherein the fluid container has a top portion and a bottom portion, the top portion forms an opening, an external circumference of the opening forms external threads, a cover is formed from an end of the connector near the fluid container, the cover forms internal threads to be screwed with the external threads of the fluid container.

8. The spray gun of claim 7, wherein the bottom portion bends toward the controller so that the fluid container is substantially L-shaped, the fluid tube also bends and has a shape corresponding to the fluid container, an end of the fluid tube away from the connector extends to an end of the bottom portion of the fluid container near the controller.

9. The spray gun of claim 8, wherein the fluid container forms a replenish inlet and a sealer detachably covering the replenish inlet to close the replenish inlet.
